(19) United States
(12) Patent Application Publication
(10) Pub. No.: US 2026/0217024 A1
(43) Pub. Date: Jul. 30, 2026

(54) LIQUID DISCHARGE HEAD SUBSTRATE, LIQUID DISCHARGE HEAD, AND LIQUID DISCHARGE APPARATUS

(71) Applicant: CANON KABUSHIKI KAISHA, Tokyo (JP)

(72) Inventors: SHINJI NAKAMURA, Kanagawa (JP); MAKOTO TAKAGI, Kanagawa (JP)

(21) Appl. No.: 19/457,886

(22) Filed: Jan. 23, 2026

(30) Foreign Application Priority Data
Jan. 29, 2025 (JP) 2025-013211

(51) Int. Cl. B41J 2/14; B41J 2/045

(52) U.S. Cl. CPC B41J 2/14072; B41J 2/04541; B41J 2/04548; B41J 2/0458; B41J 2002/14491

(57) ABSTRACT

A liquid discharge head substrate having a first side extending in a first direction is provided. The substrate includes a discharge element array including discharge elements arranged in the first direction and a supply port to supply liquid, a driving element array including driving elements corresponding to the discharge elements, arranged in the first direction, and to drive the discharge elements, a control circuit to control the driving element array, and a terminal region including terminals arranged in the first direction along the first side. At least one of the driving element array and the control circuit is arranged in a circuit region on a side opposite to the terminal region with respect to the discharge element array in a second direction crossing the first direction.

### BACKGROUND

### Field of the Technology

The present disclosure relates to a liquid discharge head substrate, a liquid discharge head, and a liquid discharge apparatus.

### Description of the Related Art

There is a growing demand for reducing sizes of liquid discharge heads. Japanese Patent Laid-Open No. 2016-128255 discloses a layout configuration of an element substrate for a liquid discharge head that can be made compact in correspondence with various substrate shapes.

There is a demand for a layout configuration of a liquid discharge head substrate for implementing further size reduction of a liquid discharge head.

### SUMMARY

Some embodiments of the present disclosure provide a technique advantageous in reducing the size of a liquid discharge head.

According to some embodiments, a liquid discharge head substrate having a first side and a second side extending in a first direction, comprising: a discharge element array including a plurality of discharge elements arranged in the first direction and a supply port configured to supply the liquid to the plurality of discharge elements; a driving element array including a plurality of driving elements corresponding to the plurality of discharge elements, arranged in the first direction, and configured to drive the discharge elements; a control circuit configured to control the driving element array; and a terminal region including a plurality of terminals arranged in the first direction along the first side and including a terminal configured to receive a power supply voltage to the liquid discharge head substrate, wherein at least one of the driving element array and the control circuit is arranged in a circuit region on a side opposite to the terminal region with respect to the discharge element array in a second direction crossing the first direction, is provided.

Features of the present disclosure will become apparent from the following description of embodiments with reference to the attached drawings. The following description of embodiments is described by way of example.

### BRIEF DESCRIPTION OF THE DRAWINGS

FIG. 1 is a view showing an example of the configuration of a liquid discharge head substrate according to the embodiment;

FIG. 2 is a view showing an example of the configuration of a liquid discharge head using the liquid discharge head substrate shown in FIG. 1;

FIGS. 3A and 3B are views showing an example of the configuration of the liquid discharge head using the liquid discharge head substrate shown in FIG. 1;

FIGS. 4A and 4B are views showing an example of the configuration of the liquid discharge head using the liquid discharge head substrate shown in FIG. 1;

FIGS. 5A and 5B are views showing an example of the configuration of the liquid discharge head substrate shown in FIG. 1;

FIG. 6 is a view showing an example of the configuration of the liquid discharge head substrate shown in FIG. 1;

FIG. 7 is a view showing a modification of the configuration of the liquid discharge head substrate shown in FIG. 1;

FIG. 8 is a view showing a modification of the configuration of the liquid discharge head substrate shown in FIG. 1; and

FIGS. 9A to 9D are views showing an example of the configuration of a liquid discharge apparatus using the liquid discharge head substrate according to the embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

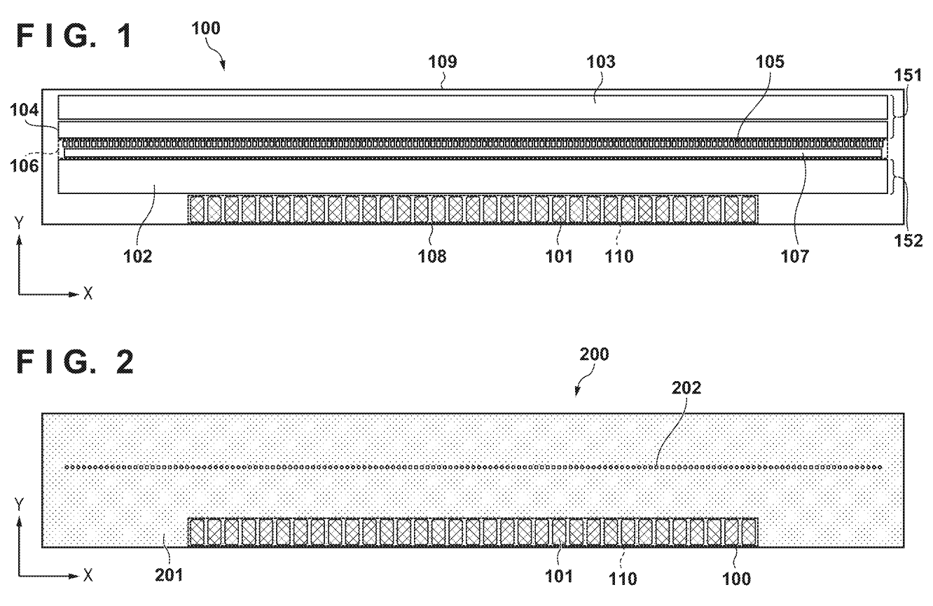

A liquid discharge head substrate according to the embodiment of the present disclosure will be described with reference to FIGS. 1 to 8. FIG. 1 is a plan view showing an example of the configuration of the layout of a liquid discharge head substrate 100 according to this embodiment. FIG. 1 shows an example in which a resistor (heater) that converts electric energy into thermal energy is used as a discharge element 105 configured to discharge a liquid. However, the present disclosure is not limited to this, and the discharge element 105 may be, for example, a piezoelectric element that converts electric energy into mechanical energy.

The liquid discharge head substrate 100 according to this embodiment includes a side 108 and a side 109 each of which extends along the X direction (first direction). The liquid discharge head substrate 100 includes, between the side 108 and the side 109, a plurality of terminals 101, a data input circuit 102, a discharge element array 106, a driving element array 104, and a control circuit 103.

The plurality of terminals 101 are arranged in the X direction along the side 108, thereby forming a terminal region 110. The plurality of terminals 101 can include a terminal configured to receive power to the liquid discharge head substrate 100. More specifically, the plurality of terminals 101 can include terminals configured to receive a power supply voltage from the outside of the liquid discharge head substrate 100 to the data input circuit 102, the control circuit 103, and the driving element array 104. In addition, the plurality of terminals 101 can include a terminal to which data for the control circuit 103 to control the plurality of driving elements 501 arranged in the driving element array 104 is input. A power supply voltage input to the terminal 101 corresponding to a voltage value necessary for a circuit to which the power supply voltage is input is supplied to a corresponding circuit such as the data input circuit 102, the control circuit 103, or the driving element array 104 via a wiring network provided in the liquid discharge head substrate 100. A terminal to which data for controlling the driving element array 104 is input is connected to the data input circuit 102 by a wiring pattern provided in the liquid discharge head substrate 100.

The data input circuit 102 converts the waveform type (for example, a differential waveform) or waveform amplitude of the externally input data for controlling the driving element array 104 into a waveform type (for example, a single-end waveform) or waveform amplitude that the control circuit 103 can handle. The converted data is supplied to the control circuit 103. The externally input data for controlling the driving element array 104 is supplied from the corresponding terminal 101 to the control circuit 103 via the data input circuit. However, the data with the waveform type or waveform amplitude that the control circuit 103 can handle may directly be input from the outside to the corresponding terminal 101. In this case, the terminal to which the externally input data for controlling the driving element array 104 is input may be connected to the control circuit 103 by a wiring pattern, and the data input circuit 102 need not be arranged. Also, for example, the data input circuit 102 may exist regardless of the waveform type or waveform amplitude of the data for controlling the driving element array 104, and the data input circuit 102 may have a function as a protection circuit configured to protect the internal circuits from electrostatic discharge (ESD).

The control circuit 103 controls the driving element array 104 in accordance with input data. In accordance with input data, the control circuit 103 sends a signal for the driving element 501 to operate to the driving element 501 corresponding to the discharge element 105 to be driven (that should discharge a liquid) among the plurality of driving elements 501 (to be described later with reference to FIGS. 5A and 5B) arranged in the driving element array 104. The driving element 501 that has received the signal drives the discharge element 105 of the operation target.

FIGS. 5A and 5B are views showing an example of the configuration of the driving element 501 using an NMOS transistor. FIG. 5A exemplifies a structure in which parts of the driving element array 104 and the discharge element array 106 shown in FIG. 1 are enlarged. FIG. 5B exemplifies a circuit diagram of the driving element 501 and the discharge element 105. As shown in FIGS. 1 and 5A, the discharge element array 106 includes the plurality of discharge elements 105 arranged in the X direction to apply energy to a liquid, and supply ports 107 configured to supply the liquid to the plurality of discharge elements 105. With respect to the discharge element array 106, the driving element array 104 includes the plurality of driving elements 501 corresponding to the plurality of discharge elements 105 and configured to drive the discharge elements 105 arranged in the X direction, as shown in FIGS. 1 and 5A.

In the configuration shown in FIG. 1, the discharge elements 105 are arranged between the driving element array 104 and the supply port 107. Also, in the configuration shown in FIG. 1, one supply port 107 extending in the X direction is arranged. On the other hand, in the configuration shown in FIG. 5A, the supply ports 107 are arranged between the driving element array 104 and the discharge elements 105. Also, a plurality of supply ports 107 are arranged along the X direction. Thus, the arrangements and shapes of the discharge elements 105 in the discharge element array 106 and the supply ports 107 are appropriately set in accordance with the configuration of the liquid discharge head substrate 100.

In the circuit diagram of the driving element 501 shown in FIG. 5B, a symbol S indicates a source 502 in FIG. 5A; a symbol G, a gate 503 in FIG. 5A; a symbol D, a drain 504 in FIG. 5A; and a symbol BG, a back gate 505 in FIG. 5A. The source 502 is connected to a potential GND, the gate 503 is connected to the control circuit 103, and the drain 504 is connected to a potential VDD via the discharge element 105. The driving element 501 adjusts a current flowing through the discharge element 105 in accordance with a signal input from the control circuit 103 to the gate 503, thereby controlling on/off of the discharge element 105. The back gate 505 may use the connection to the source 502 and the potential GND. A power supply voltage supplied to the potential GND or the potential VDD is supplied via the terminal 101 arranged in the terminal region 110.

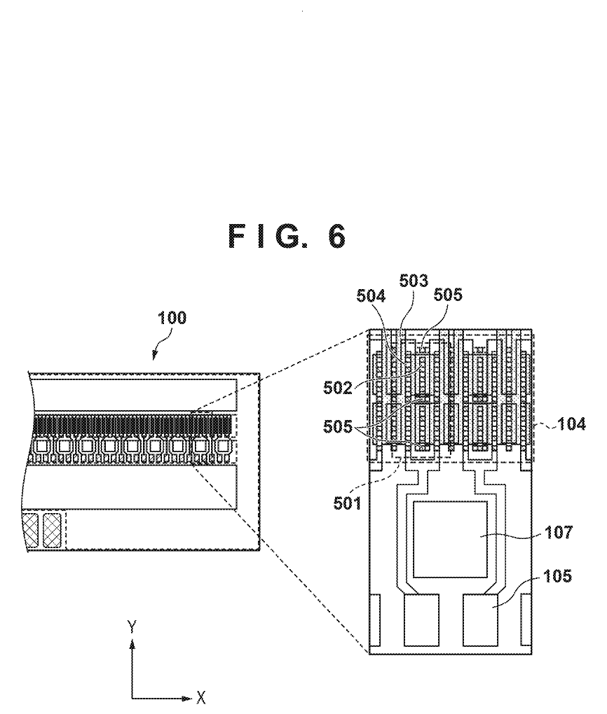

FIG. 6 is a view showing another example of the configuration of the driving element 501 shown in FIG. 5A. The driving element 501 shown in FIG. 6 has such a configuration that the size of the driving element 501 in the Y direction (second direction) shown in FIG. 5A is reduced to about 1/2 and two elements with the half size are connected in the Y direction. In the configuration in which two elements are connected in the Y direction as the driving element 501, connection to the back gate 505 can be done between the two elements and on the lower side of the driving element 501 in the Y direction in FIG. 6. That is, in the configuration shown in FIG. 6, the connection to the back gate 505 can be strengthened, as compared to the configuration shown in FIG. 5A. In the configuration shown in FIG. 6, three connecting portions to the back gate 505 are arranged in correspondence with one driving element 501. However, one or two connecting portions may be omitted depending on the characteristic of the driving element 501. Also, the back gate 505 may use the connection to the source 502 and the potential GND in at least one point. In the configurations shown in FIGS. 5A, 5B, and FIG. 6, an NMOS transistor is shown as the driving element 501. However, another appropriate switch element may be used if it can control the discharge element 105 to an on or off state. As described above, the plurality of driving elements 501 are arranged in the X direction, thereby forming the driving element array 104.

The discharge element 105 generates heat in accordance with a current flowing to the discharge element 105 when the driving element 501 is set in the on state. In this embodiment, as described above, the discharge element 105 is a resistor (heater) that converts electric energy into thermal energy. The discharge element 105 heats the liquid by generating heat, and the heated liquid is discharged.

In the configuration shown in FIG. 1, the driving element array 104 and the control circuit 103 are arranged in a circuit region 151 on the side opposite to the terminal region 110 with respect to the discharge element array 106 in the Y direction crossing (for example, orthogonal to) the X direction. The circuit region 151 is a region provided between the discharge element array 106 and the side 109 and is a region provided along the side 109. Also, the data input circuit 102 is arranged in a circuit region 152 provided between the discharge element array 106 and the terminal region 110. However, the present disclosure is not limited to this, and a part of circuits of the driving element array 104, the control circuit 103, and the data input circuit 102 may be arranged in the circuit region 151, and another part of circuits may be arranged in the circuit region 152. For example, the data input circuit 102 is arranged in the circuit region 152 close to the terminal region 110. In this case, arranging at least one of the driving element array 104 and the control circuit 103 in the circuit region 151 suffices. Also, for example, if the data input circuit 102 is not arranged, one of the driving element array 104 and the control circuit 103 may be arranged in the circuit region 151, and the other may be arranged in the circuit region 152. Furthermore, for example, if the data input circuit 102 is not arranged, the driving element array 104 and the control circuit 103 may be arranged in the circuit region 151.

In this embodiment, the circuit region 151 in which the driving element array 104 and the control circuit 103 are arranged is set on the side opposite to the terminal region 110 with respect to the discharge element array 106. The circuit region 151 can be covered with an insulating layer configured to protect the arranged circuits. It is therefore possible to secure the surface of the insulating layer as a region to adhere a nozzle material 201 with discharge ports 202 to be described next with reference to FIG. 2. If the circuit region 151 is not set, a region to adhere the nozzle material 201 needs to be secured between the discharge element array 106 and the side 109. By setting the circuit region 151, the region used only for adhering the nozzle material 201 need not be secured, and an increase of the size of the liquid discharge head substrate 100 in the Y direction is suppressed. That is, size reduction of the liquid discharge head substrate 100 can be implemented and, for example, an increase of the cost of products can be suppressed.

FIG. 2 is a plan view showing an example of the configuration of a liquid discharge head including the above-described liquid discharge head substrate 100, and a nozzle material 201 including a plurality of discharge ports 202 whose liquid discharge is controlled by the liquid discharge head substrate 100. A liquid discharge head 200 according to this embodiment has a configuration in which the nozzle material 201 is superimposed on a region of the liquid discharge head substrate 100 other than the terminal region 110. The nozzle material 201 is provided with the plurality of discharge ports 202 along the X direction, and each of the plurality of discharge ports 202 can be arranged to overlap a corresponding one of the plurality of discharge elements 105 arranged on the liquid discharge head substrate 100.

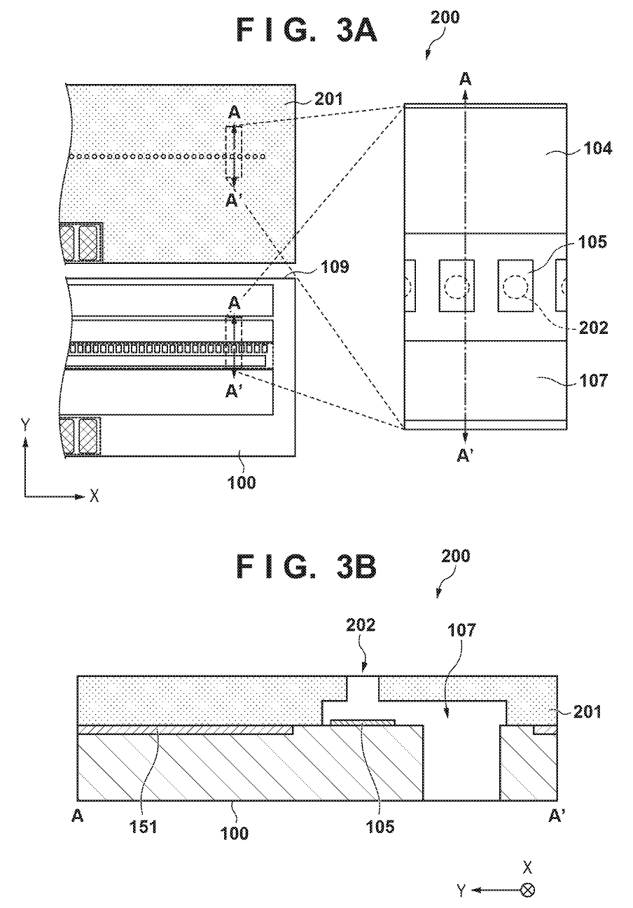

FIG. 3A is a perspective view showing a part of the liquid discharge head 200 on the periphery of the discharge elements 105 in an enlarged state, which is viewed from above. FIG. 3B is a sectional view showing an example of the configuration taken along a line A - A' in FIG. 3A. Each of the plurality of discharge ports 202 is arranged such that it overlaps immediately above the corresponding discharge element 105. As described above, in the liquid discharge head substrate 100, the circuit region 151 is set between the discharge element array 106 and the side 109, and at least a part of the circuit region 151 overlaps the nozzle material 201. For example, as shown in FIG. 1, the control circuit 103 and the driving element array 104 may be arranged in the circuit region 151. The surface of the circuit region 151 is covered with an insulating layer (not shown), and at least a part of a portion of the insulating layer covering the circuit region 151 functions as a region to adhere the nozzle material 201. The nozzle material 201 is arranged in close contact with the region. The control circuit 103 and the driving element array 104 can be arranged under a region, where the nozzle material 201 is arranged, of the insulating layer arranged to cover the circuit region 151.

As shown in FIG. 3B, the nozzle material 201 includes a space configured to supply the liquid from the supply port 107 to the discharge element 105. When the discharge element 105 generates heat, the liquid supplied by the space is heated and obtains energy. The liquid that has obtained energy is discharged from the discharge port 202.

Consider a case where the circuit region 151 in which the control circuit 103 or the driving element array 104 can be arranged is not set between the discharge element array 106 and the side 109. This is a case where all circuits such as the control circuit 103, the driving element array 104, and the data input circuit 102 are arranged between the discharge element array 106 and the terminal region 110. In this case, to adhere the nozzle material 201 to the liquid discharge head substrate 100, a region used only for bonding the nozzle material 201 needs to be secured between the discharge element array 106 and the side 109. Hence, the liquid discharge head substrate 100 needs to be large in the Y direction. In the configuration according to this embodiment, an increase of the sizes of the liquid discharge head substrate 100 and the liquid discharge head 200 in the Y direction is suppressed. That is, size reduction of the liquid discharge head substrate 100 and the liquid discharge head 200 can be implemented and, for example, an increase of the cost of products can be suppressed.

Also, for example, assume that the above-described liquid discharge head substrate 100 has the same size as a liquid discharge head substrate according to a comparative example which includes the same constituent elements as those of the liquid discharge head substrate 100 and in which the above-described circuit region 151 is not set. In this case, in the liquid discharge head substrate 100 according to the present disclosure, since the circuit region 151 in which the driving element array 104 and the control circuit 103 are arranged is set, a space to further arrange an additional circuit can be formed in the circuit region 152. That is, if the liquid discharge head substrate 100 has the same size as the liquid discharge head substrate of the comparative example, an additional circuit can be arranged and, therefore, it is possible to achieve higher functionality than the liquid discharge head substrate of the comparative example. In addition, such an additional circuit can be added to a region (circuit region 152) that is close to the terminal region 110 and has better wiring easiness.

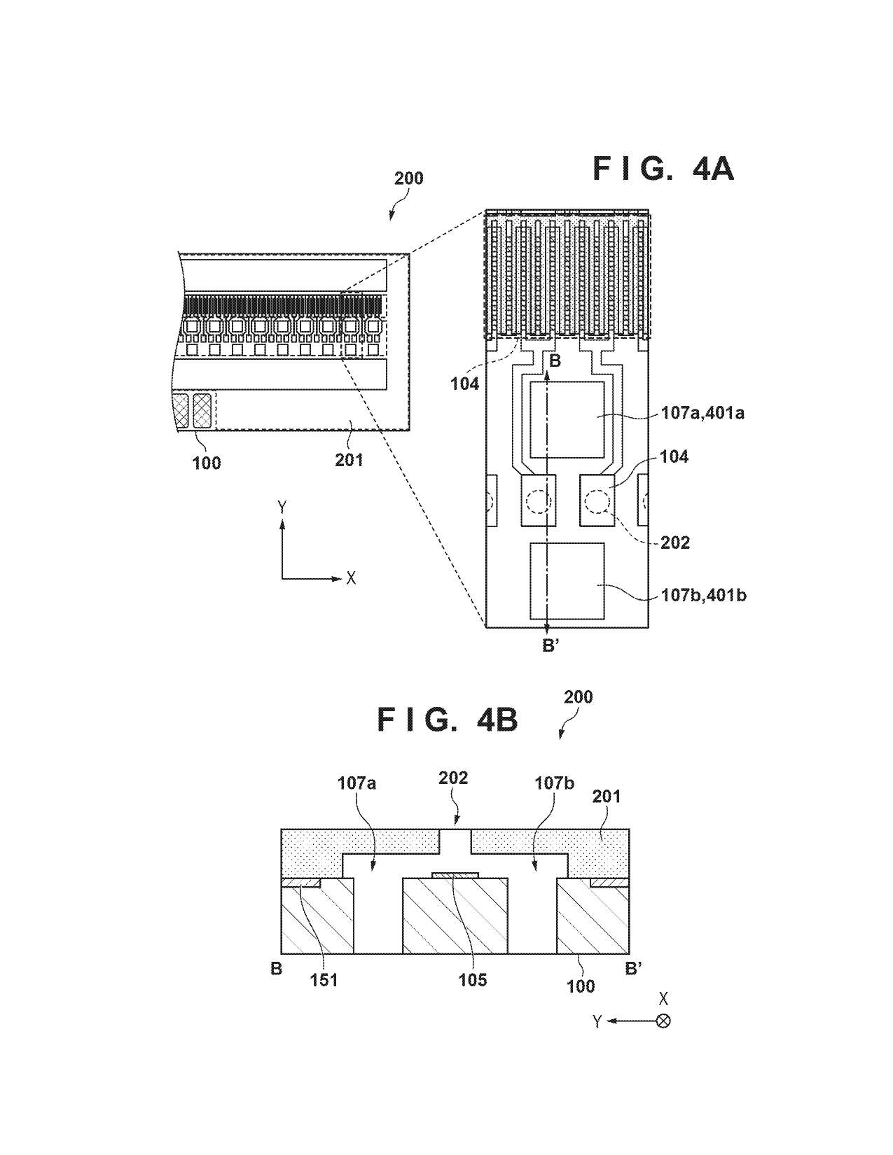

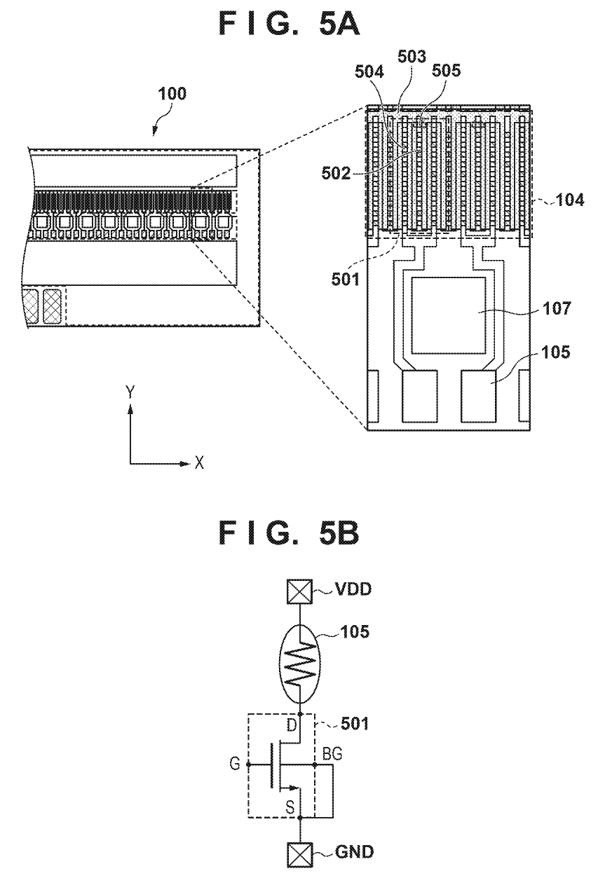

FIGS. 4A and 4B are views showing a modification of the liquid discharge head 200 shown in FIGS. 3A and 3B. FIG. 4A is a perspective view showing a part of the liquid discharge head 200 on the periphery of the discharge elements 105 in an enlarged state, which is viewed from above. FIG. 4B is a sectional view showing an example of the configuration taken along a line B - B' in FIG. 4A, which is another example of the configuration taken along the line A - A' in FIG. 3A. As shown in FIGS. 4A and 4B, in the discharge element array 106, a plurality of supply ports 107a and a plurality of supply ports 107b are arranged in the X direction such that one supply port is arranged on each of the upper and lower sides of the discharge element 105 in the Y direction. Both the supply port 107a and the supply port 107b can be used as supply ports to supply a liquid, but one of them may be used as an ejection port. The ejection port is used to recover the liquid that is not discharged. For example, the supply port 107a may be used to supply the liquid, and the supply port 107b may be used as an ejection port for ejecting the liquid, and vice versa. In the Y direction, the discharge elements 105 are arranged between the supply ports 107a (or the supply ports 107b) configured to supply the liquid and the supply ports 107b (or the supply ports 107a) functioning as the ejection ports configured to eject the liquid. This makes it possible to efficiently supply the liquid onto the discharge elements 105.

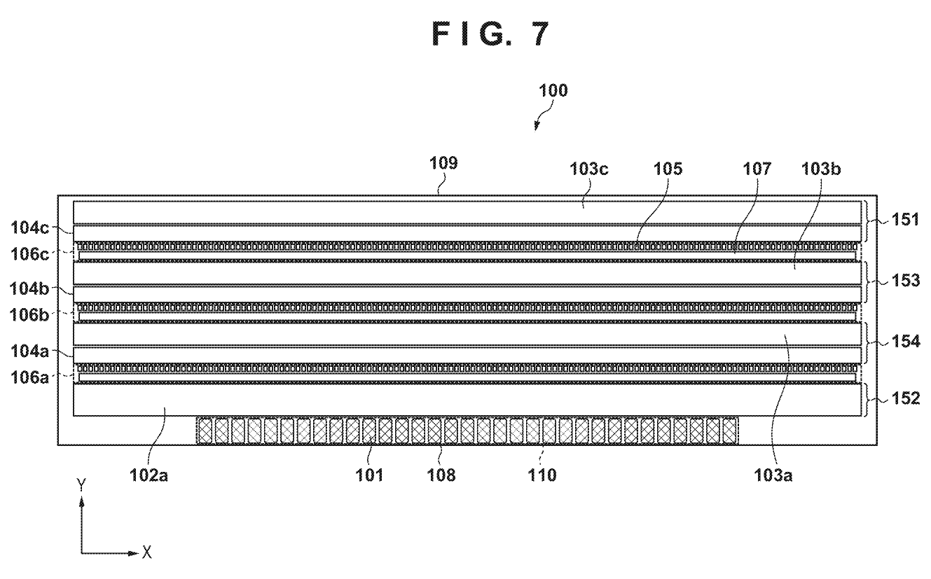

FIG. 7 is a view showing a modification of the liquid discharge head substrate 100 shown in FIG. 1. In the configuration shown in FIG. 1, one combination of the discharge element array 106, the driving element array 104 configured to drive the discharge element array 106, and the control circuit 103 configured to control the driving element array 104 is arranged. On the other hand, in the configuration shown in FIG. 7, a plurality of sets each including the discharge element array 106, the driving element array 104, and the control circuit 103 are arranged in the Y direction. In the configuration shown in FIG. 7, three sets of discharge element arrays 106a to 106c, driving element arrays 104a to 104c, and control circuits 103a to 103c are arranged.

In this case, at least one driving element array 104 or control circuit 103 of the plurality of driving element arrays 104a to 104c and the plurality of control circuits 103a to 103c is arranged on the side opposite to the terminal region 110 in the Y direction with respect to the discharge element array 106c arranged at the position farthest from the terminal region 110 in the plurality of discharge element arrays 106a to 106c. This obviates the necessity of securing the region only for adhering the nozzle material 201 and suppresses an increase of the size of the liquid discharge head substrate 100 in the Y direction, as described above. That is, size reduction of the liquid discharge head substrate 100 can be implemented and, for example, an increase of the cost of products can be suppressed.

In the configuration shown in FIG. 7, in the circuit region 151 provided between the side 109 and the discharge element array 106c arranged at the position farthest from the terminal region 110, the driving element array 104c and the control circuit 103c are arranged. However, the present disclosure is not limited to this, and only the driving element array 104c or only the control circuit 103c may be arranged in the circuit region 151. For example, the driving element array 104c may be arranged in the circuit region 151, and the control circuit 103c may be arranged in a circuit region 153 provided between the discharge element array 106b and the discharge element array 106c. In the circuit regions 151 to 154 including a circuit region 154 provided between the discharge element array 106a and the discharge element array 106b, the data input circuit 102, the

driving element arrays 104a to 104c, the control circuits 103a to 103c, and the like are appropriately arranged in accordance with a configuration required for the liquid discharge head substrate 100. The discharge element arrays 106a to 106c may have the same configuration or may include a discharge element array having a different configuration. The driving element arrays 104a to 104c and the control circuits 103a to 103c may also have the same configuration or may have different configurations in accordance with the discharge element arrays 106a to 106c to be driven. Also, in the configuration shown in FIG. 7, the combination of three sets of discharge element arrays 106, driving element arrays 104, and control circuits 103 is shown. However, the combination may include two sets or four or more sets.

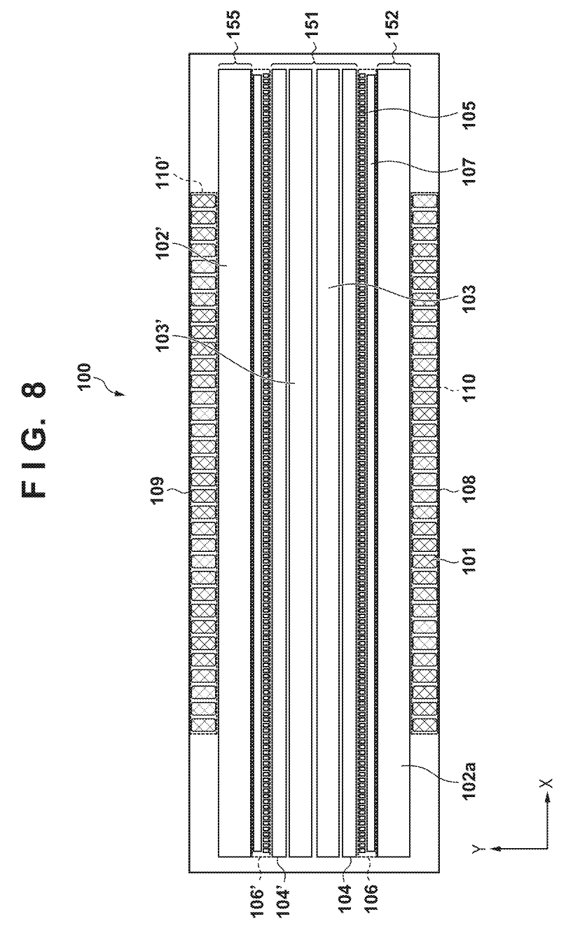

FIG. 8 is a view showing a modification of the liquid discharge head substrate 100 shown in FIG. 1. As compared to the configuration shown in FIG. 1, the liquid discharge head substrate 100 shown in FIG. 8 further includes a terminal region 110', a discharge element array 106', a driving element array 104', a control circuit 103', and a data input circuit 102'. The terminal region 110' includes a plurality of terminals 101 arranged in the X direction along the side 109. The discharge element array 106' is arranged between the discharge element array 106 and the terminal region 110' in the Y direction. The driving element array 104' includes a plurality of driving elements 501 corresponding to the plurality of discharge elements 105 arranged in the discharge element array 106' and configured to drive the discharge elements arranged in the X direction. The control circuit 103' is arranged to control the driving element array 104'. The data input circuit 102' is connected to, among the plurality of terminals 101 arranged in the terminal region 110', a terminal to which data for the control circuit 103' to control the plurality of discharge elements 105 arranged in the discharge element array 106' is input, and receives the data. Components different from the configuration shown in FIG. 1 will mainly be described below, and a description of components that can be the same will appropriately be omitted.

The terminals 101 arranged in the terminal region 110' can include terminals configured to supply a power supply voltage from the outside of the liquid discharge head substrate 100 to the data input circuit 102', the control circuit 103', and the driving element array 104'. In addition, the plurality of terminals 101 arranged in the terminal region 110' can include a terminal to which data for the control circuit 103' to control the plurality of driving elements 501 arranged in the driving element array 104' is input, as described above.

For example, if the same power supply voltage is supplied to a certain terminal 101 arranged in the terminal region 110 and a certain terminal arranged in the terminal region 110', these terminals may be electrically connected to each other via a wiring network provided in the liquid discharge head substrate 100. Also, for example, data for the control circuit 103' to control the plurality of driving elements 501 arranged in the driving element array 104' may be input from the terminal 101 arranged in the terminal region 110. Conversely, data for the control circuit 103 to control the plurality of driving elements 501 arranged in the driving element array 104 may be input from the terminal 101 arranged in the terminal region 110'.

Like the data input circuit 102, the data input circuit 102' converts data for controlling externally input data for controlling the driving element array 104 into a waveform type or waveform amplitude that the control circuit 103' can handle, and supplies the data to the control circuit 103'. Also, as described above, if the data with the waveform type or waveform amplitude that the control circuit 103' can handle is directly input from the outside to the corresponding terminal 101 in the terminal region 110', the data input circuit 102' need not be arranged. Also, for example, the data input circuit 102' may exist regardless of the waveform type or waveform amplitude of the data for controlling the driving element array 104', and the data input circuit 102' may have a function as a protection circuit configured to protect the internal circuits from ESD.

Like the control circuit 103, the control circuit 103' controls the driving element array 104' in accordance with input data. The control circuit 103 may control at least some driving elements of the plurality of driving elements 501 arranged in the driving element array 104'. Conversely, the control circuit 103' may control at least some driving elements of the plurality of driving elements 501 arranged in the driving element array 104. The configurations and operations of the driving elements 501 arranged in the driving element array 104', the discharge elements 105 arranged in the discharge element array 106', and the supply ports 107 (ejection ports) may be the same as described above, and a description thereof will be omitted here.

In the configuration shown in FIG. 8, the above-described circuit region 151 provided on the side opposite to the terminal region 110 with respect to the discharge element array 106 in the Y direction is arranged between the discharge element array 106 and the discharge element array 106'. In the circuit region 151, the driving element array 104 and the control circuit 103' are arranged. Also, the data input circuit 102' is arranged in a circuit region 155 between the discharge element array 106' and the terminal region 110'. However, the present disclosure is not limited to this, and a part of circuits of the driving element array 104', the control circuit 103', and the data input circuit 102' may be arranged in the circuit region 151, and another part of circuits may be arranged in the circuit region 155. For example, the data input circuit 102' is arranged in the circuit region 155 close to the terminal region 110'. In this case, the driving element array 104' and the control circuit 103' may be arranged in the circuit region 151 or may be arranged in the circuit region 155. Also, for example, if the data input circuit 102 is not arranged, at least one of the driving element array 104 and the control circuit 103 may be arranged in the circuit region 155. Furthermore, for example, if the data input circuit 102 is not arranged, the driving element array 104 and the control circuit 103 may be arranged in the circuit region 155.

The circuit regions 151, 152, and 155 can function as a region to adhere the nozzle material 201 to the liquid discharge head substrate 100. Hence, in the configuration of the liquid discharge head substrate 100 shown in FIG. 8, the circuit regions 151, 152, and 155 are set, and appropriate circuits are arranged. This obviates the necessity of securing the region only for bonding the nozzle material 201. As a result, an increase of the sizes of the liquid discharge head substrate 100 and the liquid discharge head 200 in the Y direction is suppressed. That is, size reduction of the liquid discharge head substrate 100 and the liquid discharge head 200 can be implemented and, for example, an increase of the cost of products can be suppressed.

In the configuration shown in FIG. 8, like the configuration shown in FIG. 7, the combination of three or more sets of discharge element arrays 106, driving element arrays 104, and control circuits 103 may be arranged. In this case, the circuit region 155 is provided between the discharge element array 106 farthest from the terminal region 110 and the terminal region 110', in other words, between the discharge element array 106 closest to the terminal region 110' and the terminal region 110'. Also, it can be said that the circuit region 152 is provided between the discharge element array 106 closest to the terminal region 110 and the terminal region 110', in other words, between the discharge element array 106 farthest from the terminal region 110' and the terminal region 110'. Circuit regions can be provided between the discharge element arrays 106. Appropriate circuits can be arranged in each circuit region in accordance with the components arranged in the liquid discharge head substrate 100. If a plurality of discharge element arrays 106 are arranged, the discharge element arrays 106 may have the same configuration, or discharge element arrays 106 having different configurations may be arranged. The plurality of driving element arrays 104 and the plurality of control circuits 103 corresponding to the plurality of discharge element arrays 106 may also have the same configuration or may have different configurations in accordance with the discharge element arrays 106 to be driven.

### Other Embodiments

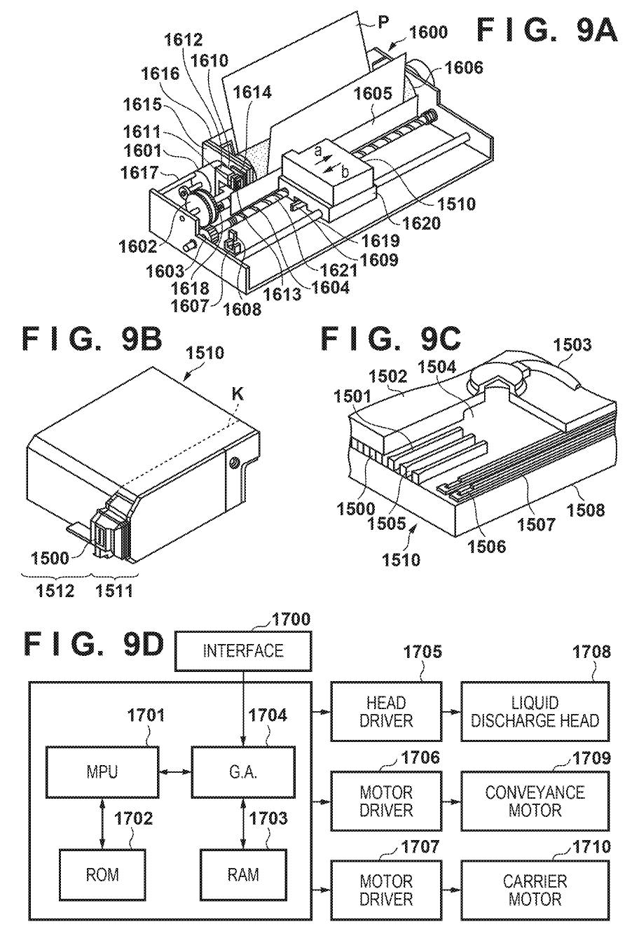

A liquid discharge apparatus using the above-described liquid discharge head substrate 100 will be explained here with reference to FIGS. 9A to 9D. FIG. 9A exemplifies the internal configuration of a liquid discharge apparatus 1600 typified by an inkjet printer, a facsimile apparatus, or a copying machine. In this example, the liquid discharge apparatus may also be called a printing apparatus. The liquid discharge apparatus 1600 includes a liquid discharge head 1510 that discharges a liquid (in this example, ink or a printing material) to a predetermined medium P (in this example, a print medium such as paper). In this example, the liquid discharge head may also be called a printhead. The liquid discharge head 1510 is mounted on a carriage 1620, and the carriage 1620 can be attached to a lead screw 1621 having a helical groove 1604. The lead screw 1621 can rotate in synchronization with rotation of a driving motor 1601 via driving force transmission gears 1602 and 1603. The liquid discharge head 1510 can move in a direction indicated by an arrow a or b along a guide 1619 together with the carriage 1620.

The medium P is pressed by a paper press plate 1605 in the carriage moving direction and fixed to a platen 1606. The liquid discharge apparatus 1600 performs liquid discharge (in this example, print) to the medium P conveyed on the platen 1606 by a conveyance unit (not shown) by reciprocating the liquid discharge head 1510.

The liquid discharge apparatus 1600 confirms the position of a lever 1609 provided on the carriage 1620 via photocouplers 1607 and 1608, and switches the rotational direction of the driving motor 1601. A support member 1610 supports a cap member 1611 for covering the nozzle (a liquid discharge port or simply a discharge port) of the liquid discharge head 1510. A suction portion 1612 performs recovery processing of the liquid discharge head 1510 by sucking the interior of the cap member 1611 via an intra-cap opening 1613. A lever 1617 is provided to start recovery processing by suction, and moves along with movement of a cam 1618 engaged with the carriage 1620. A driving force from the driving motor 1601 is controlled by a well-known transmission mechanism such as a clutch switch.

A main body support plate 1616 supports a moving member 1615 and a cleaning blade 1614. The moving member 1615 moves the cleaning blade 1614 to perform recovery processing of the liquid discharge head 1510 by wiping. The liquid discharge apparatus 1600 includes a controller (not shown) and the controller controls driving of each mechanism described above.

FIG. 9B exemplifies the outer appearance of the liquid discharge head 1510. The liquid discharge head 1510 can include a head portion 1511 having a plurality of nozzles 1500, and a tank (liquid storage portion) 1512 that holds a liquid to be supplied to the head portion 1511. The tank 1512 and the head portion 1511 can be separated at, for example, a broken line K and the tank 1512 is interchangeable. The liquid discharge head 1510 has an electrical contact (not shown) for receiving an electrical signal from the carriage 1620 and discharges a liquid in accordance with the electrical signal. The tank 1512 has a fibrous or porous liquid holding member (not shown) and the liquid holding member can hold a liquid.

FIG. 9C exemplifies the internal configuration of the liquid discharge head 1510. The liquid discharge head 1510 includes a base 1508, flow path wall members 1501 that are arranged on the base 1508 and form flow paths 1505, and a top plate 1502 having a liquid supply path 1503. The base 1508 may be the above-described liquid discharge head substrate 100. As discharge elements or liquid discharge elements, heaters 1506 (which can also be referred to as electrothermal transducers or heat generating resistive elements) are arrayed on the substrate (liquid discharge head substrate) of the liquid discharge head 1510 in correspondence with the respective nozzles 1500 (discharge ports). Each heater 1506 is driven to generate heat by turning on a driving element (a switching element such as a transistor) provided in correspondence with the heater 1506.

A liquid from the liquid supply path 1503 is stored in a common liquid chamber 1504 and supplied to each nozzle 1500 via the corresponding flow path 1505. The liquid supplied to each nozzle 1500 is discharged from the nozzle 1500 in response to driving of the heater 1506 corresponding to the nozzle 1500.

FIG. 9D exemplifies the system configuration of the liquid discharge apparatus 1600. The liquid discharge apparatus 1600 includes an interface 1700, an MPU 1701, a ROM 1702, a RAM 1703, and a gate array (G.A.) 1704. The interface 1700 receives from the outside an external signal for executing liquid discharge. The ROM 1702 stores a control program to be executed by the MPU 1701. The RAM 1703 saves various signals and data such as the above-mentioned external signal for liquid discharge and data supplied to the liquid discharge head 1708. The gate array 1704 performs supply control of data to the liquid discharge head 1708 and control of data transfer between the interface 1700, the MPU 1701, and the RAM 1703.

The liquid discharge apparatus 1600 further includes a head driver 1705, motor drivers 1706 and 1707, a conveyance motor 1709, and a carrier motor 1710. The carrier motor 1710 conveys the liquid discharge head 1708. The conveyance motor 1709 conveys the medium P. The head driver 1705 drives the liquid discharge head 1708. The motor drivers 1706 and 1707 drive the conveyance motor 1709 and the carrier motor 1710, respectively.

When a driving signal is input to the interface 1700, it can be converted into data for liquid discharge between the gate array 1704 and the MPU 1701. Each mechanism performs a desired operation in accordance with this data. In this manner, the liquid discharge head 1708 is driven.

According to the present disclosure, it is possible to provide a technique advantageous in reducing the size of a liquid discharge head.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-013211, filed January 29, 2025, which is hereby incorporated by reference herein in its entirety.

What is claimed is:

1. A liquid discharge head substrate having a first side and a second side extending in a first direction, comprising:
a discharge element array including a plurality of discharge elements arranged in the first direction and a supply port configured to supply liquid to the plurality of discharge elements;
a driving element array including a plurality of driving elements corresponding to the plurality of discharge elements, arranged in the first direction, and configured to drive the discharge elements;
a control circuit configured to control the driving element array; and
a terminal region including a plurality of terminals arranged in the first direction along the first side and including a terminal configured to receive a power supply voltage to the liquid discharge head substrate,
wherein at least one of the driving element array and the control circuit is arranged in a circuit region on a side opposite to the terminal region with respect to the discharge element array in a second direction crossing the first direction.

2. The substrate according to claim 1, wherein a surface of the circuit region is covered with an insulating layer, and
at least a part of a portion of the insulating layer covering the circuit region is a region where a nozzle material in which a discharge port whose liquid discharge is controlled by the liquid discharge head substrate is provided.

3. The substrate according to claim 1, wherein the discharge element array further includes an ejection port configured to eject the liquid.

4. The substrate according to claim 3, wherein in the second direction, the plurality of discharge elements are arranged between the supply port and the ejection port.

5. The substrate according to claim 1, wherein the plurality of terminals include a first terminal to which data for the control circuit to control the plurality of driving elements is input,
the liquid discharge head substrate further comprises a data input circuit configured to receive the data, and the data is supplied from the first terminal to the control circuit via the data input circuit, and
a part of circuits of the driving element array, the control circuit, and the data input circuit are arranged in the circuit region, and another part of circuits are arranged between the discharge element array and the terminal region.

6. The substrate according to claim 5, wherein the driving element array and the control circuit are arranged in the circuit region, and
the data input circuit is arranged between the discharge element array and the terminal region.

7. The substrate according to claim 1, wherein the plurality of terminals include a first terminal which is connected to the control circuit and to which data for the control circuit to control the driving element array is input.

8. The substrate according to claim 1, wherein the circuit region is a region arranged along the second side.

9. The substrate according to claim 1, further comprising a plurality of discharge element arrays including the discharge element array, a plurality of driving element arrays including the driving element array, and a plurality of control circuits including the control circuit,
wherein, of the plurality of driving element arrays and the plurality of control circuits, at least one driving element array or control circuit is arranged, in the second direction, on a side opposite to the terminal region with respect to a discharge element array arranged at a position farthest from the terminal region among the plurality of discharge element arrays.

10. The substrate according to claim 1, further comprising:
a second terminal region including a plurality of terminals arranged in the first direction along the second side;
a second discharge element array arranged between the discharge element array and the second terminal region in the second direction;
a second driving element array including a plurality of driving elements corresponding to the plurality of discharge elements arranged in the second discharge element array, arranged in the first direction, and configured to drive the discharge elements; and
a second control circuit configured to control the second driving element array,
wherein the circuit region is arranged between the discharge element array and the second discharge element array in the second direction, and
at least one of the second driving element array and the second control circuit is arranged in a second circuit region between the second discharge element array and the second terminal region.

11. The substrate according to claim 10, wherein the plurality of terminals arranged in the second terminal region include a second terminal which is connected to the second control circuit and to which second data for controlling the plurality of discharge elements arranged in the second discharge element array is input.

12. The substrate according to claim 1, further comprising:
a second terminal region including a plurality of terminals arranged in the first direction along the second side;
a second discharge element array arranged between the discharge element array and the second terminal region in the second direction;
a second driving element array including a plurality of driving elements corresponding to the plurality of discharge elements arranged in the second discharge element array and arranged in the first direction;
a second control circuit configured to control the second driving element array; and
a second data input circuit connected to, of the plurality of terminals arranged in the second terminal region, a second terminal to which second data for the second control circuit to control the plurality of discharge elements arranged in the second discharge element array is input, and configured to receive the second data,
wherein the circuit region is arranged between the discharge element array and the second discharge element array in the second direction, and
at least one of the second driving element array, the second control circuit, and the second data input circuit is arranged in a second circuit region between the second discharge element array and the second terminal region.

13. The substrate according to claim 12, wherein the second driving element array and the control circuit are arranged in the circuit region, and
the second data input circuit is arranged in the second circuit region.

14. The substrate according to claim 10, wherein a surface of the second circuit region is covered with an insulating layer, and
at least a part of a portion of the insulating layer covering the second circuit region is a region where a nozzle material in which a discharge port whose liquid discharge is controlled by the liquid discharge head substrate is provided.

15. The substrate according to claim 10, wherein the second discharge element array includes a second supply port and a second ejection port arranged along the second direction to supply and eject the liquid to the plurality of discharge elements arranged in the second discharge element array.

16. The substrate according to claim 15, wherein in the second direction, the plurality of discharge elements arranged in the second discharge element array are arranged between the second supply port and the second ejection port.

17. A liquid discharge head comprising:
the liquid discharge head substrate according to claim 1; and
a nozzle material including a discharge port whose liquid discharge is controlled by the liquid discharge head substrate.

18. A liquid discharge head comprising:
the liquid discharge head substrate according to claim 2; and
a nozzle material including a plurality of discharge ports whose liquid discharge is controlled by the liquid discharge head substrate,
wherein the plurality of discharge ports are arranged to overlap the plurality of discharge elements, and
the nozzle material is arranged in close contact with a region for arranging the nozzle material.

19. A liquid discharge apparatus comprising:
the liquid discharge head according to claim 17; and
a unit configured to supply, to the liquid discharge head, a driving signal for discharging a liquid.
